(19) United States
(12) Patent Application Publication
(10) Pub. No.: US 2026/0241774 A1
(43) Pub. Date: Aug. 20, 2026

(54) AIR-CONDITIONING DEVICE

(71) Applicant: Sanden Corporation, Isesaki-shi, Gunma (JP)

(72) Inventors: Hiroshi HONDA, Isesaki-shi, Gunma (JP); Joji ARAI, Isesaki-shi, Gunma (JP); Yasushi MURAKOSHI, Isesaki-shi, Gunma (JP); Shoji TAKEMOTO, Isesaki-shi, Gunma (JP); Noritaka MARUTA, Isesaki-shi, Gunma (JP)

(73) Assignee: Sanden Corporation, Isesaki-shi, Gunma (JP)

(21) Appl. No.: 19/164,163

(22) PCT Filed: May 22, 2024
(86) PCT No.: PCT/JP2024/018822

§ 371 Date: Sep. 10, 2025

(30) Foreign Application Priority Data
Jun. 22, 2023 (JP) 2023-102439

(51) Int. Cl. B60H 1/32

(52) U.S. Cl. CPC B60H 1/32331

(57) ABSTRACT

An air-conditioning apparatus includes: a refrigerant circuit including a compressor, a condenser, a decompression device, an evaporator, and a refrigerant channel that connects the compressor, the condenser, the decompression device, and the evaporator, in which a refrigerant circulates; and a condensate water receiving portion placed between the evaporator and the condenser below the evaporator, the condensate water receiving portion being configured to guide condensate water produced in the evaporator toward a surface of the condenser in a front-rear direction intersecting a width direction of the evaporator, and the condensate water receiving portion includes: a receiving surface that receives the condensate water, and a plurality of guide projections spaced apart from one another in the width direction, each of the guide projections protruding upward from the receiving surface and extending in the front-rear direction.

### TECHNICAL FIELD

The present invention relates to an air-conditioning apparatus.

### BACKGROUND ART

An air-conditioning apparatus is conventionally known in which, for example, a compressor, a condenser, a decompression device, an evaporator, a fan, and a control device, which make up a refrigerant circuit, are accommodated in one housing.

In this type of air-conditioning apparatus, as described in, for example, Patent Literature 1, a condenser (radiator) is placed below an evaporator, and condensate water produced in the evaporator is caused to flow down to the condenser and is brought into contact with the condenser to cool the condenser, thereby encouraging an improvement in the efficiency of the refrigeration cycle.

### CITATION LIST

### Patent Literature

Patent Literature 1: JP-A-2022-1798

### SUMMARY OF INVENTION

### Problems to be Solved by Invention

Incidentally, if the known air-conditioning apparatus such as described in Patent Literature 1 is installed in a non-horizontal place or tilts during traveling while mounted on a vehicle, there arises a problem that the condensate water is not appropriately guided from the evaporator to the condenser, and the condenser cannot be sufficiently cooled by the condensate water.

Hence, the present invention provides an air-conditioning apparatus capable of guiding condensate water from an evaporator to a condenser regardless of the installation position and improving operation efficiency.

### Solution to Problems

An air-conditioning apparatus according to one aspect of the present invention includes: a refrigerant circuit including a compressor, a condenser, a decompression device, an evaporator, and a refrigerant channel that connects the compressor, the condenser, the decompression device, and the evaporator, in which a refrigerant circulates; and a condensate water receiving portion placed between the evaporator and the condenser below the evaporator, the condensate water receiving portion being configured to guide condensate water produced in the evaporator toward a surface of the condenser in a front-rear direction intersecting a width direction of the evaporator, in which the condensate water receiving portion includes: a receiving surface that receives the condensate water, and a plurality of guide projections spaced apart from one another in the width direction, each of the guide projections protruding upward from the receiving surface and extending in the front-rear direction.

In the above air-conditioning apparatus, the condensate water receiving portion may include: a receiving portion main body that includes a part of the receiving surface as a main body-side receiving surface and collects the condensate water; and a guide portion that includes a part of the receiving surface as a guide-side receiving surface, has one edge connected to the receiving portion main body, has the other edge close to or in contact with the surface of the condenser, and has the guide-side receiving surface below the main body-side receiving surface, and the plurality of guide projections may include a plurality of main body-side projections provided on the main body-side receiving surface of the receiving portion main body portion and/or a plurality of guide-side projections provided on the guide-side receiving surface of the guide portion.

In the above air-conditioning apparatus, the guide portion may be larger in dimension in the width direction than the receiving portion main body, the plurality of guide projections may include the plurality of guide-side projections, and the number of the guide-side projections provided to a portion of the guide portion in the width direction, the position of the portion in the width direction matching the receiving portion main body (hereinafter, a lateral matching portion), may be greater than the number of the guide-side projections provided to a portion of the guide portion in the width direction, the position of the portion in the width direction being different from the receiving portion main body (hereinafter, a lateral non-matching portion).

In the above air-conditioning apparatus, the plurality of guide-side projections may be provided only to the lateral matching portion of the guide portion.

In the above air-conditioning apparatus, the guide portion may be provided in such a manner as to protrude from the receiving portion main body toward one side in the width direction, and each of the plurality of guide-side projections may be inclined to the one side in the width direction, from the one edge side toward the other edge side of the guide portion.

In the above air-conditioning apparatus, the plurality of guide projections may include the plurality of guide-side projections, and in terms of each of the plurality of guide-side projections, assuming that an end on the one edge side of the guide portion is defined as a guide proximal end and an end on the other edge side is defined as a guide distal end, spacing between the guide distal ends of the plurality of guide-side projections may be larger than spacing between the guide proximal ends.

In the above air-conditioning apparatus, the evaporator and the condenser may be placed in such a manner as to exchange heat with air flowing in the front-rear direction, the plurality of guide projections may include the plurality of main body-side projections, and a channel for the condensate water formed by the main body-side projections adjacent to each other in the width direction and the receiving surface may be provided with a lateral protruding portion protruding upward from the receiving surface in a part of the channel in the width direction.

In the above air-conditioning apparatus, a plurality of the lateral protruding portions may be provided to one channel, spaced apart in the front-rear direction, and the plurality of the lateral protruding portions that is provided in the one channel and is adjacent to each other in the front-rear direction may be placed at positions displaced in the width direction.

In the above air-conditioning apparatus, assuming that the plurality of the lateral protruding portions that is provided in the one channel and is adjacent to each other in the front-rear direction is defined as a first protruding portion and a second protruding portion, the first protruding portion may be connected to one of the main body-side projections adjacent to each other in the width direction, and the second protruding portion may be connected to the other of the main body-side projections adjacent to each other in the width direction and overlap the first protruding portion as viewed in the front-rear direction.

The above air-conditioning apparatus may be mounted on a vehicle.

### Effects of Invention

According to the above air-conditioning apparatus, it is possible to guide the condensate water from the evaporator to the condenser regardless of the installation position and to improve operation efficiency.

### BRIEF DESCRIPTION OF DRAWINGS

FIG. 1 is a perspective view of an air-conditioning apparatus according to an embodiment of the present invention as viewed obliquely from the front.

FIG. 2 is a perspective view of the above air-conditioning apparatus as viewed obliquely from the rear.

FIG. 3 is a perspective view of the above air-conditioning apparatus as viewed obliquely from the front, and is a diagram illustrating the air-conditioning apparatus from which a part of a housing has been removed for convenience of description.

FIG. 4 is a perspective view of the above air-conditioning apparatus as viewed obliquely from the rear, and is a diagram illustrating the air-conditioning apparatus from which the part of the housing has been removed for convenience of description.

FIG. 5 is a side view of the above air-conditioning apparatus as viewed from the other side in a width direction.

FIG. 6 is a vertical cross-sectional view of the above air-conditioning apparatus, and is a cross-sectional view taken along line V-V of FIG. 5.

FIG. 7 is a vertical cross-sectional view of the above air-conditioning apparatus, and is a cross-sectional view taken along line IV-IV of FIG. 4.

FIG. 8 is a perspective view of a bottom portion of an evaporation-side inner case of an evaporator in the above air-conditioning apparatus.

FIG. 9 is a top view of the bottom portion of the evaporation-side inner case of the evaporator in the above air-conditioning apparatus.

FIG. 10 is a side view of the bottom portion of the evaporation-side inner case of the evaporator in the above air-conditioning apparatus as viewed from the other side in the width direction.

FIG. 11 is a cross-sectional view of the evaporation-side inner case of the evaporator in the above air-conditioning apparatus, and is a cross-sectional view taken along line X-X of FIG. 10, illustrating a part of a condensate water receiving portion included in the evaporation-side inner case.

FIG. 12 is a diagram illustrating a modification of the above condensate water receiving portion, and is a cross-sectional view at a position corresponding to the cross section taken along line X-X of FIG. 10.

An air-conditioning apparatus 100 according to an embodiment of the present invention is described hereinafter. The air-conditioning apparatus 100 of the embodiment is, for example, a small air-conditioning apparatus such as a spot cooler dedicated to cooling mounted on a vehicle, but, for example, the installation place and size are not particularly limited.

### Overall Configuration

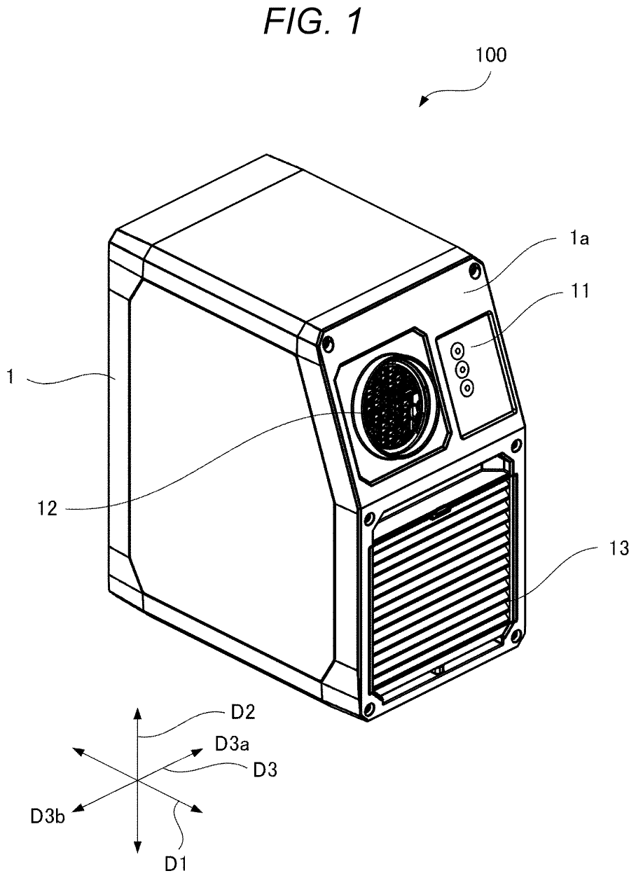

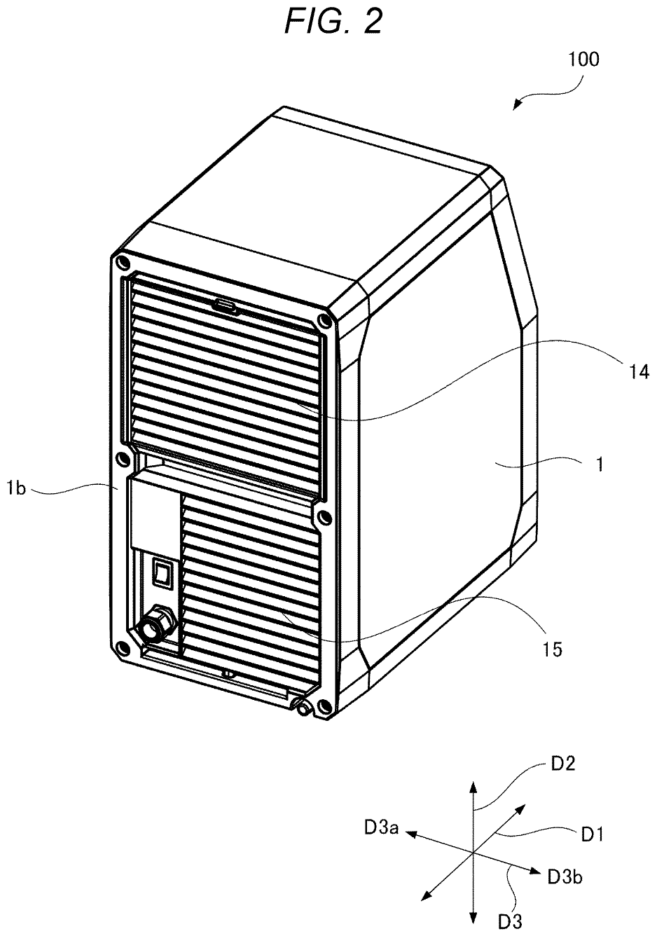

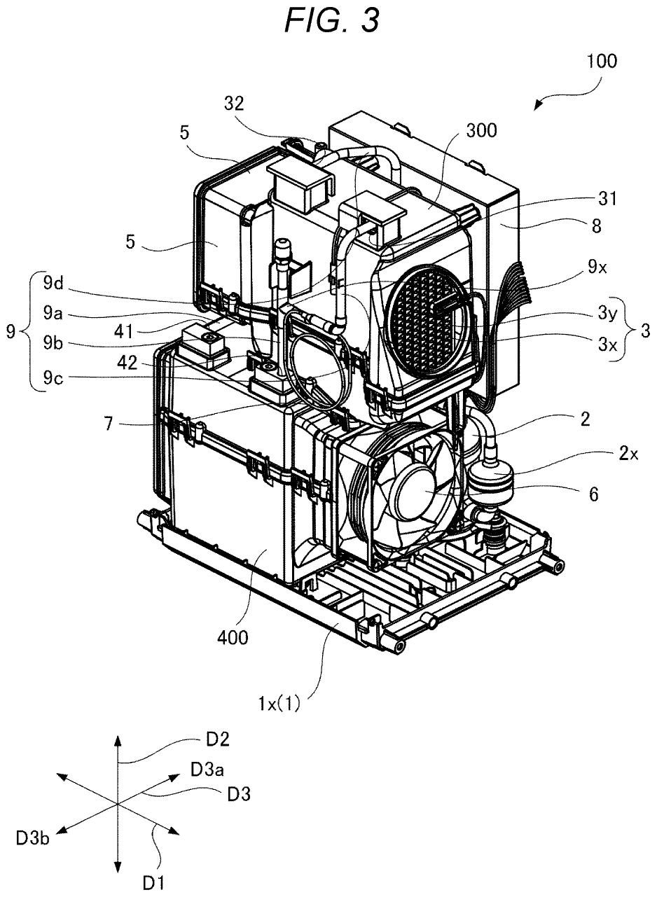

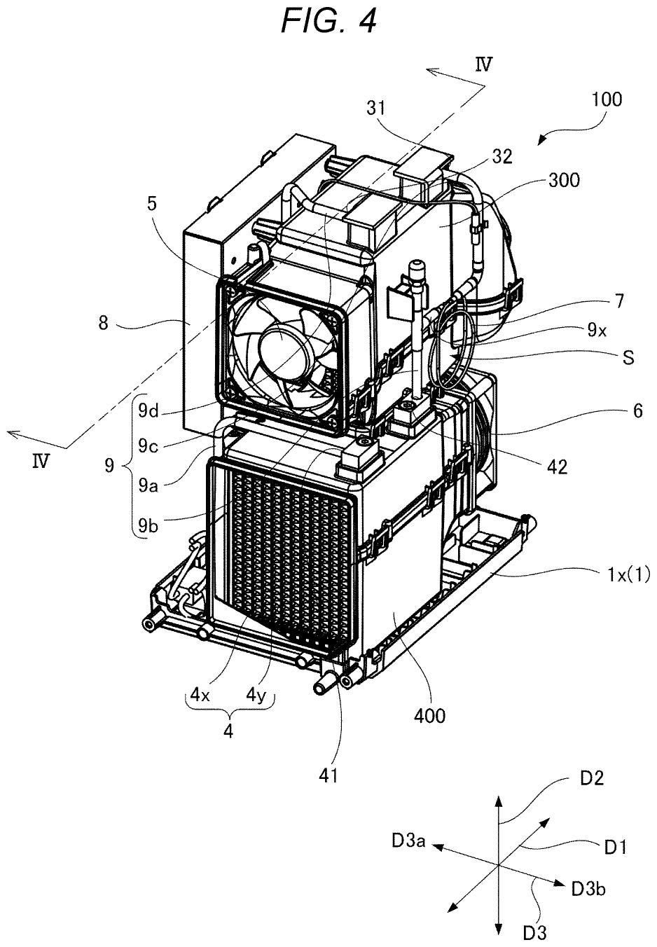

As illustrated in FIGS. 1 and 2, the air-conditioning apparatus 100 includes a housing 1 and, as illustrated in FIGS. 3 and 4, the air-conditioning apparatus 100 further includes a compressor 2, an evaporator 3, a condenser 4, an evaporator-side fan 5, a condenser-side fan 6, a decompression device 7, and a control device 8, which are accommodated in the housing 1, and includes a refrigerant pipe 9 that connects the compressor 2, the condenser 4, the evaporator 3, and the decompression device 7 to form a refrigerant channel through which a refrigerant flows between these components.

Note that for convenience of description, FIG. 3 is a diagram illustrating the air-conditioning apparatus 100 from which the housing 1 excluding a bottom plate 1x has been removed from the general view illustrated in FIG. 1, and FIG. 4 is a diagram illustrating the air-conditioning apparatus 100 from which the housing 1 excluding the bottom plate 1x has been removed from the general view illustrated in FIG. 2.

In addition, the compressor 2, the condenser 4, the decompression device 7, the evaporator 3, and the refrigerant pipe 9 make up a refrigerant circuit in which the refrigerant circulates in the order of the compressor 2, the condenser 4, the decompression device 7, and the evaporator 3. In addition to the refrigerant circuit, the air-conditioning apparatus 100 further includes a condensate water receiving portion 20 that guides condensate water W produced in the evaporator 3 to the condenser 4.

### Housing

Return to FIG. 1. The housing 1 as a whole has an approximately rectangular parallelepiped shape. In addition, a control panel 11, an air discharge port 12, and an air intake port 13 are provided to a front surface 1a, which faces forward in a front-rear direction D1, of the housing 1. The control panel 11 is provided in such a manner as to be located forward of the control device 8 (refer to FIG. 3) accommodated in the housing 1, and is configured in such a manner as to allow the control device 8 to be operated.

Moreover, the air discharge port 12 is provided in such a manner as to be located forward of the evaporator 3 (refer to FIG. 3) accommodated in the housing 1, and is configured in such a manner as to discharge air (cold air) that has passed through the evaporator 3. Furthermore, the air intake port 13 is provided in such a manner as to be located forward of the condenser-side fan 6 (refer to FIG. 3) accommodated in the housing 1, and is configured in such a manner as to take air into the housing 1 toward the condenser 4.

Moreover, as illustrated in FIG. 2, an air intake port 14 and an exhaust port 15 are provided to a rear surface 1b, which faces rearward in the front-rear direction D1, of the housing 1. The air intake port 14 is provided in such a manner as to be located rearward of the evaporator-side fan 5 (refer to FIG. 4) accommodated in the housing 1, and is configured in such a manner as to take air into the housing 1 toward the evaporator 3. Moreover, the exhaust port 15 is provided in such a manner as to be located rearward of the condenser 4 (refer to FIG. 4) accommodated in the housing 1, and is configured in such a manner as to discharge air (exhaust) that has passed through the condenser 4.

### Condenser

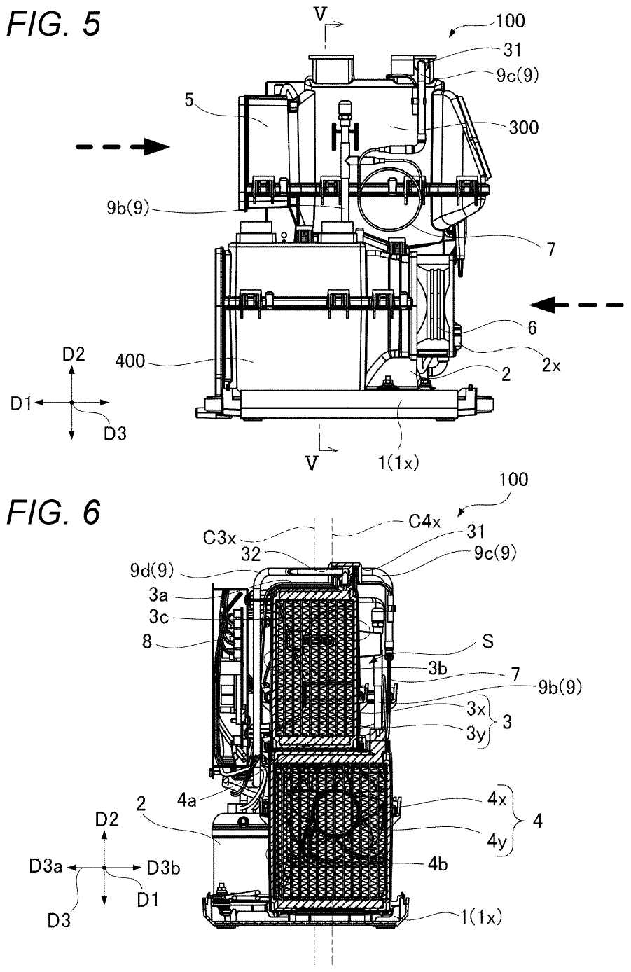

As illustrated in FIG. 4, the condenser 4 is placed in a lower part in the housing 1. The condenser 4 is a fin and tube heat exchanger in which a plurality of fins 4x for heat exchange is placed in such a manner as to extend in the front-rear direction D1, and the adjacent fins 4x are connected to one another by tubes 4y extending in an up-down direction D2. In addition, air flows in the front-rear direction D1 between the fins 4x for heat exchange, and therefore, heat is exchanged between the air and the refrigerant. In the embodiment, it is configured in such a manner that the air flows through the condenser 4 from the front to the rear in the front-rear direction D1 as indicated with a broken line arrow in FIG. 5. Note that the condenser 4 is accommodated in a condensation-side inner case 400 in the housing 1.

### Condenser-Side Fan

Return to FIG. 4. The condenser-side fan 6 is provided forward of the condenser 4 in the front-rear direction D1 in the housing 1. The condenser-side fan 6 sucks air (outside air) through the air intake port 13 (refer to FIG. 1) of the housing 1, causes the air to flow from the front to the rear through air channels between the fins 4x in the condenser 4, and discharges the air that has exchanged heat with the condenser 4 through the exhaust port 15 (refer to FIG. 2).

### Evaporator

Return to FIG. 3. The evaporator 3 is placed above the condenser 4 in the housing 1. The evaporator 3 is a fin and tube heat exchanger in which a plurality of fins 3x for heat exchange is placed in such a manner as to extend in the front-rear direction D1, and the adjacent fins 3x are connected to one another by tubes 3y extending in the up-down direction D2. In addition, it is configured in such a manner that air flows in the front-rear direction D1 between the fins 3x for heat exchange, and therefore, heat is exchanged between the air and the refrigerant. In the embodiment, it is configured in such a manner that the air flows through the evaporator 3 from the rear to the front as indicated with a broken line arrow in FIG. 5. Note that the evaporator 3 is accommodated in an evaporation-side inner case 300 in the housing 1.

Here, as illustrated in FIG. 6, the evaporator 3 is placed above the condenser 4 in such a manner as to overlap a part of an upper surface 4a of the condenser 4 in the housing 1. In order to secure a heat exchange area of the condenser 4, the condenser 4 is configured to be larger in dimension in the width direction D3 than the evaporator 3.

In addition, a center position C3x of the evaporator 3 in the width direction D3 is offset to one side D3a in the width direction D3 from a center position C4x of the condenser 4 in the width direction D3. Therefore, the evaporator 3 is placed above the condenser 4 in such a manner as to overlap the part of the upper surface 4a of the condenser 4. Note that in the embodiment, side surfaces 3b and 4b, which face the one side D3a in the width direction D3, of the evaporator 3 and the condenser 4 are placed at substantially the same position in the width direction D3. In addition, a space above a region, which does not overlap the evaporator 3, of the upper surface 4a of the condenser 4, the region being on the other side D3b in the width direction D3 relative to the evaporator 3, is defined as a non-overlapping space S.

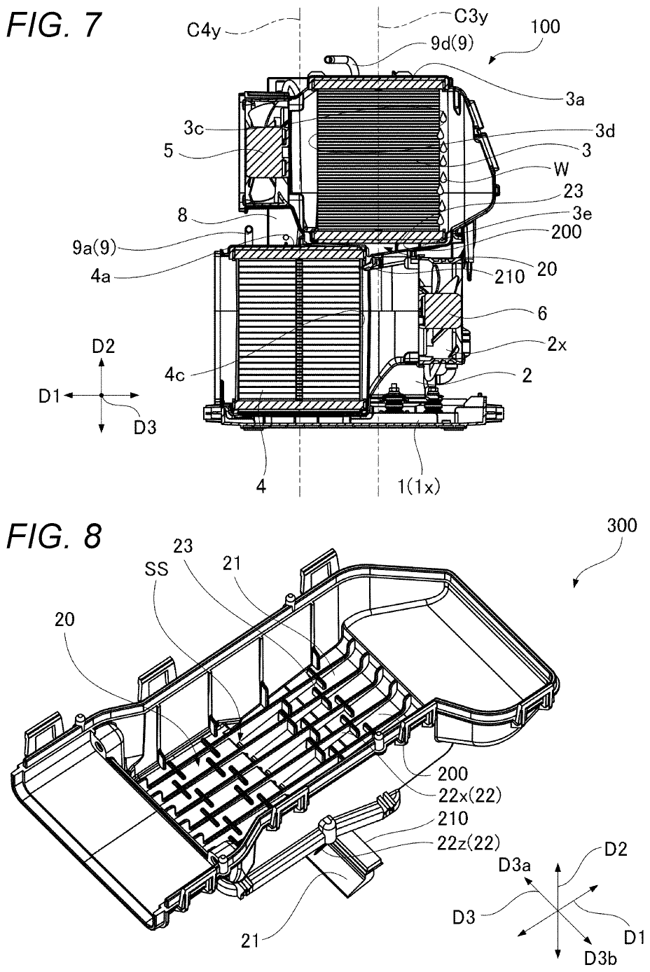

Moreover, as illustrated in FIG. 7, a center position C3y of the evaporator 3 in the front-rear direction D1 is offset to the front from a center position C4y of the condenser 4 in the front-rear direction D1 (refer to FIG. 5).

### Evaporator-Side Fan

The evaporator-side fan 5 is provided rearward of the evaporator 3 in the front-rear direction D1 in the housing 1. The evaporator-side fan 5 is configured in such a manner as to suck air (outside air) through the air intake port 14 (refer to FIG. 2), cause the air to flow from the rear to the front through air channels between the fins 3x in the evaporator 3, and discharge the air (cold air) that has exchanged heat with the evaporator 3 through the air discharge port 12 (refer to FIG. 1).

### Decompression Device

Return to FIG. 4. The decompression device 7 is a device that decompresses and expands the refrigerant, and includes a capillary tube in the embodiment. In addition, the decompression device 7 is placed in the non-overlapping space S in the housing 1. In other words, the decompression device 7 is placed on the other side D3b in the width direction D3 relative to the evaporator 3.

### Control Device

The control device 8 has a board to which various electronic components including an inverter are attached, and converts and outputs, for example, the voltage and frequency of power supplied from a power supply to control the rotation speed of a motor that drives the compressor 2. Moreover, the control device 8 receives a signal inputted into the control panel 11 (refer to FIG. 1) of the housing 1, and controls the refrigerant circuit in response to the received signal. In the embodiment, the control device 8 is placed on the one side D3a in the width direction D3 relative to the evaporator 3, the one side D3a being opposite to the non-overlapping space S in the width direction D3.

### Compressor

Return to FIG. 3. The compressor 2 is a device that compresses the refrigerant, and is placed in the housing 1, on the one side D3a in the width direction D3 relative to the condenser 4 and below the control device 8. Moreover, in the embodiment, the compressor 2 is placed adjacent to the condenser 4 in the width direction D3 at a position closer to the front side of the condenser 4. Moreover, an accumulator 2x that separates the refrigerant into gas and liquid is placed forward of the compressor 2.

### Refrigerant Pipes

As illustrated in FIGS. 3 and 4, the refrigerant pipe 9 includes a first pipe 9a that connects the compressor 2 and the condenser 4, a second pipe 9b that connects the condenser 4 and the decompression device 7, a third pipe 9c that connects the decompression device 7 and the evaporator 3, and a fourth pipe 9d that connects the evaporator 3 and the compressor 2.

The first pipe 9a extends upward from the compressor 2 and then extends toward the other side D3b in the width direction D3 along the upper surface 4a of the condenser 4, and is connected to the condenser 4 at a condenser inlet 41 that is formed in the condensation-side inner case 400 at a position closer to the rear side of the condenser 4 and is open toward the non-overlapping space S and toward the one side D3a in the width direction D3.

The second pipe 9b is placed forward of the condenser inlet 41, extends upward from a condenser outlet 42 that is formed in the condensation-side inner case 400 and is open toward the non-overlapping space S and upward, and then extends forward via a bent portion 9x and is connected to the decompression device 7. In other words, the second pipe 9b is placed adjacent to the decompression device 7 and rearward of the decompression device 7.

The third pipe 9c extends upward from the decompression device 7 and is connected to the evaporator 3 at an evaporator inlet 31 that is formed in an upper surface of the evaporation-side inner case 300 at a position closer to the front side of the evaporator 3 and is open toward the other side D3b in the width direction D3.

The fourth pipe 9d extends from an evaporator outlet 32 that is formed, rearward of the evaporator inlet 31, in the upper surface of the evaporation-side inner case 300 and is open toward the one side D3a in the width direction D3, toward the one side D3a in the width direction D3 along an upper surface 3a (refer to FIG. 6) of the evaporator 3, and then extends downward along the side surfaces 3b and 4b (refer to FIG. 6), which face the one side D3a in the width direction D3, of the evaporator 3 and the condenser 4, and is connected to the compressor 2 through the accumulator 2x.

Through the refrigerant pipe 9 placed in this manner, the refrigerant is compressed by the compressor 2 to become high temperature and high pressure, and then flows into the condenser 4 through the first pipe 9a to become low temperature and high pressure. The refrigerant then flows into the decompression device 7 through the second pipe 9b and is decompressed to become low temperature and low pressure, and flows into the evaporator 3 through the third pipe 9c to become high temperature and low pressure. The refrigerant then flows into the compressor 2 through the fourth pipe 9d and is compressed again to become high temperature and high pressure. The air-conditioning apparatus 100 is configured in such a manner as to perform cooling operation by repeating such a refrigeration cycle.

### Condensate Water Receiving Portion

Next, the condensate water receiving portion 20 is described in detail with reference to FIGS. 7 to 11.

As illustrated in FIG. 7, the condensate water receiving portion 20 guides the condensate water W produced by moisture in the air condensing and adhering to the evaporator 3, toward a front surface 4c of the condenser 4 in the front-rear direction D1. In addition, in the embodiment, the condensate water receiving portion 20 forms a bottom portion of the evaporation-side inner case 300.

Specifically, the condensate water receiving portion 20 includes a receiving portion main body 200 including a part of a receiving surface 21 placed below the evaporator 3, a guide portion 210 including a part of the receiving surface 21, and a plurality of guide projections 22 protruding upward from the receiving surface 21 as illustrated in FIG. 8.

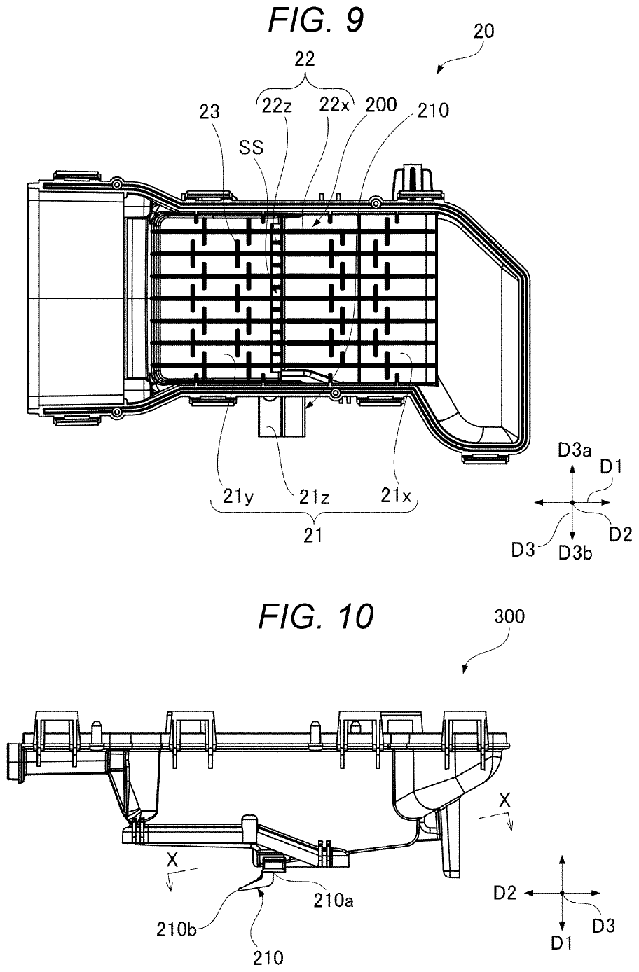

As illustrated in FIG. 9, the receiving surface 21 includes a front receiving surface 21x that extends from a position forward of a front surface 3c (refer to FIG. 7) of the evaporator 3 to a substantially center position of the evaporator 3, the substantially center position being a position in the middle in the front-rear direction D1, a rear receiving surface 21y that is placed rearward of the front receiving surface 21x across a gap SS and extends up to a position rearward of a rear surface 3d (refer to FIG. 7) of the evaporator 3, and a guide-side receiving surface 21z that is connected to the front receiving surface 21x and extends rearward from the gap SS.

The front receiving surface 21x is an inclined surface inclined downward from the front to the rear. On the other hand, the rear receiving surface 21y is a non-inclined surface (a horizontal plane when the air-conditioning apparatus 100 is installed on a horizontal plane) extending in the front-rear direction D1 along a bottom surface 3e (refer to FIG. 7) of the evaporator 3.

The guide-side receiving surface 21z is an inclined surface inclined downward from the front to the rear.

### Receiving Portion Main Body

The receiving portion main body 200 includes the front receiving surface 21x and the rear receiving surface 21y as a main body-side receiving surface being a part of the receiving surface 21, and collects the condensate water W. The collected condensate water W flows into the guide portion 210 described below through the above gap SS.

### Guide Portion

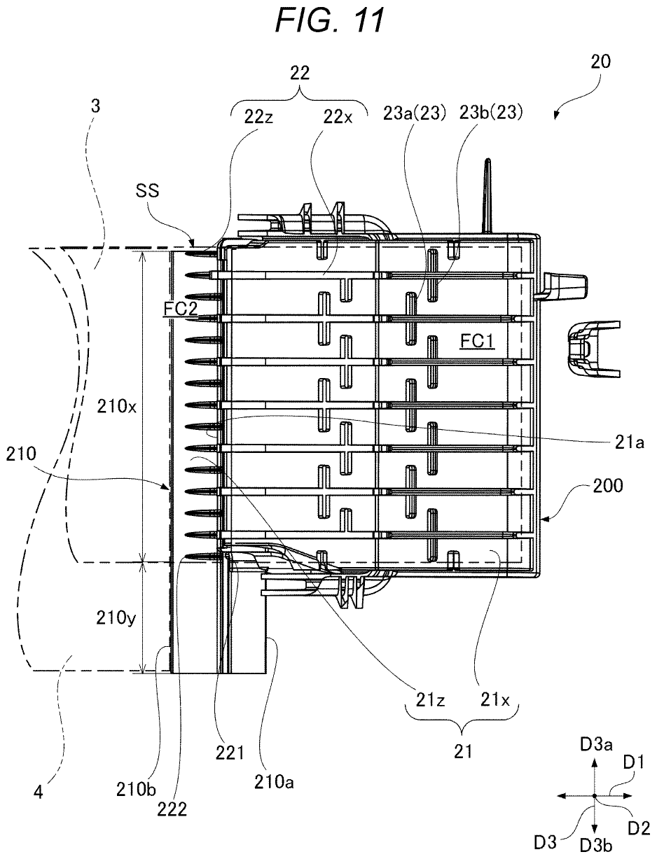

The guide portion 210 includes the guide-side receiving surface 21z as a part of the receiving surface 21. In addition, as illustrated in FIG. 10, a front edge 210a as one edge of the guide portion 210 is connected to the receiving portion main body 200 in the above gap SS, and a rear edge 210b as the other edge is close to or in contact with the front surface 4c (refer to FIG. 7) as a surface of the condenser 4. The guide-side receiving surface 21z is located below the front receiving surface 21x and the rear receiving surface 21y, and is connected to the front receiving surface 21x via a stepped surface 21a that forms an inner surface facing rearward in the gap SS as illustrated in FIG. 11. Moreover, the guide portion 210 is formed of a soft material such as resin in such a manner as to be capable of elastically contacting the condenser 4.

Furthermore, the guide portion 210 is larger in dimension in the width direction D3 than the receiving portion main body 200, and is provided in such a manner as to protrude from the receiving portion main body 200 only toward the other side D3b in the width direction D3. Note that an end portion of the guide portion 210 on the one side D3a in the width direction D3 is placed at substantially the same position in the width direction D3 as an end portion of the receiving portion main body 200 on the one side D3a in the width direction D3. Consequently, the receiving portion main body 200 is placed throughout the length of the evaporator 3 in the width direction D3, and the guide portion 210 is placed throughout the length of the condenser 4 in the width direction D3. Hereinafter, a portion of the guide portion 210 in the width direction D3, the position of which in the width direction D3 matches the receiving portion main body 200, is defined as a lateral matching portion 210x, and a portion (the remaining portion) of the guide portion 210 in the width direction D3, the position of which in the width direction D3 is different from the receiving portion main body 200, is defined as a lateral non-matching portion 210y.

### Guide Projections

The plurality of guide projections 22 includes a plurality of main body-side projections 22x provided on the front receiving surface 21x and the rear receiving surface 21y of the receiving portion main body 200, and a plurality of guide-side projections 22z provided on the guide-side receiving surface 21z of the guide portion 210.

Each of the plurality of main body-side projections 22x extends in the front-rear direction D1 all the way from the front receiving surface 21x to the rear receiving surface 21y, and protrudes upward from the receiving surfaces 21x and 21y. The main body-side projections 22x are spaced apart from one another in the width direction D3, and the main body-side projections 22x adjacent to one another in the width direction D3 and the receiving surfaces 21x and 21y form main body-side channels FC1 serving as channels for the condensate water W.

### Lateral Protruding Portions

Lateral protruding portions 23 protruding upward from the receiving surfaces 21x and 21y are provided in parts of the main body-side channels FC1 in the width direction D3. A plurality of the lateral protruding portions 23 is spaced apart in the front-rear direction D1 in each of the main body-side channels FC1, and a plurality of the lateral protruding portions 23 that is provided in one main body-side channel FC1 and is adjacent to each other in the front-rear direction D1 is placed at positions displaced in the width direction D3 (excluding the channels FC1 at both ends in the width direction D3). More specifically, in the embodiment, assume that one of the plurality of the lateral protruding portions 23 adjacent to each other in the front-rear direction D1 is a first protruding portion 23a, and the other is a second protruding portion 23b. The first protruding portion 23a is connected to only one of the main body-side projections 22x adjacent to each other in the width direction D3 (the projection 22x on the one side D3a in the width direction D3). Moreover, the second protruding portion 23b is connected to only the other of the main body-side projections 22x adjacent to each other in the width direction D3 (the projection 22x on the other side D3b in the width direction D3), and overlaps the first protruding portion 23a as viewed in the front-rear direction D1.

Furthermore, each of the lateral protruding portions 23 is in contact with the bottom surface 3e (refer to FIG. 7) of the evaporator 3 to support the evaporator 3 from below.

### Guide-Side Projections

Each of a plurality of guide-side projections 22z extends in the front-rear direction D1 on the guide-side receiving surface 21z and protrudes upward from the guide-side receiving surface 21z. The guide-side projections 22z are spaced apart from one another in the width direction D3, and the guide-side projections 22z adjacent to one another in the width direction D3 and the guide-side receiving surface 21z form guide-side channels FC2 serving as channels for the condensate water W. The plurality of guide-side projections 22z also function as ribs that increase the strength of the guide portion 210.

In addition, in the embodiment, the guide-side projections 22z are provided only to the lateral matching portion 210x of the guide portion 210.

Moreover, in terms of each of the plurality of guide-side projections 22z, assuming that an end on the front edge 210a (drawing side of the guide portion 210 is defined as a guide proximal end 221, and an end on the rear edge 210b side is defined as a guide distal end 222, the guide distal end 222 is located forward of the rear edge 210b, and the guide proximal end 221 is placed at the same position in the front-rear direction D1 as the front edge on the guide-side receiving surface 21z, and connected to the stepped surface 21a.

### Operations and Effects

According to the air-conditioning apparatus 100 of the embodiment described above, the plurality of guide projections 22 is provided to the condensate water receiving portion 20 that guides the condensate water W produced in the evaporator 3 to the surface of the condenser 4. Therefore, the condensate water W dropping from the evaporator 3 can be guided toward the condenser 4 in the front-rear direction D1. Hence, even if the air-conditioning apparatus 100 is installed in a non-horizontal place or tilts during traveling while mounted on a vehicle, it is possible to reliably guide the condensate water W toward the condenser 4, cool the condenser 4 with the condensate water W, and improve the operation efficiency of the air-conditioning apparatus 100.

Furthermore, the rear edge 210b of the guide portion 210 is close to or in contact with the front surface 4c that is the surface of the condenser 4. Therefore, the condensate water W can be more reliably guided by the guide portion 210 toward the condenser 4. Moreover, the plurality of guide projections 22 includes the main body-side projections 22x provided on the receiving surfaces 21x and 21y of the receiving portion main body 200 and the guide-side projections 22z provided on the guide-side receiving surface 21z of the guide portion 210. Therefore, the collected condensate water W can be always guided in the front-rear direction D1 from the receiving portion main body 200 to the guide portion 210.

Moreover, the guide-side projections 22z are provided only to the lateral matching portion 210x of the guide portion 210. In other words, the guide-side projections 22z are placed in a region, in which the receiving portion main body 200 is provided, of the guide portion 210 in the width direction D3. In this manner, the guide-side projections 22z are provided only to a position necessary and sufficient to guide the condensate water W that has flowed from the receiving portion main body 200 into the guide portion 210, and the condensate water W can be guided to the condenser 4 while the number of the guide-side projections 22z installed is kept to the necessary bare minimum.

Moreover, the lateral protruding portions 23 are provided in the channels FC1 for the condensate water W in the receiving portion main body 200. Therefore, it is possible to avert a situation in which a part of the air flowing through the evaporator 3 and the condenser 4 in the front-rear direction D1 flows in the front-rear direction D1 through the channels FC1, and it is possible to block the flow of air that is not provided to exchange heat in the evaporator 3 and the condenser 4. Hence, the heat exchange efficiency can be improved, which leads to an improvement in the operation efficiency of the air-conditioning apparatus 100. In particular, the lateral protruding portions 23 of the embodiment support the evaporator 3 from below while in contact with the bottom surface 3e (refer to FIG. 7) of the evaporator 3. Therefore, the effect of blocking the flow of air through the channels FC1 is very high.

Moreover, the lateral protruding portions 23 adjacent to each other in the front-rear direction D1 in one channel FC1 are placed at positions displaced in the width direction D3. Therefore, the air that attempts to flow through the channel FC1 reliably comes into contact with and is blocked by the lateral protruding portions 23, and the effect of blocking the flow of air through the channel FC1 can be further enhanced.

Here, the present invention is not limited to the above-mentioned embodiment, and various modifications can be added thereto without deviating from the purport of the present invention.

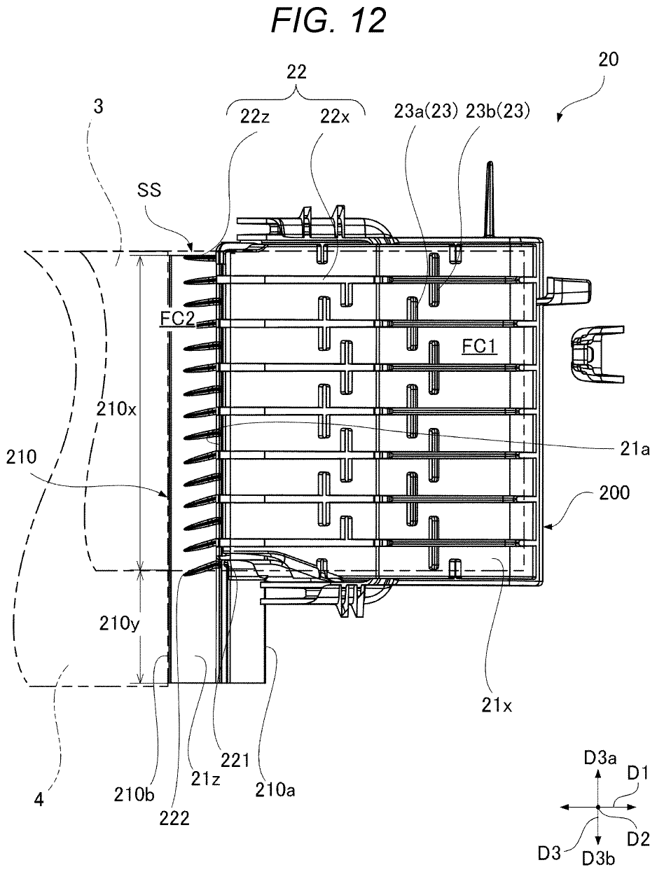

For example, as illustrated in FIG. 12, each of the plurality of guide-side projections 22z may be inclined to the other side D3b in the width direction D3, from the front edge 210a side toward the rear edge 210b side of the guide portion 210. In this case, the condensate water W from the receiving portion main body 200 can also be guided to the lateral non-matching portion 210y, which protrudes from the receiving portion main body 200, of the guide portion 210, and the condensate water W can be brought into contact in a wide area with the condenser 4 having a larger dimension in the width direction D3 than the evaporator 3, and the cooling effect on the condenser 4 can be improved. Note that as illustrated in FIG. 12, the plurality of guide-side projections 22z may be placed in such a manner that the inclination angle of each of the guide-side projections 22z increases gradually from the one side D3a toward the other side D3b in the width direction D3, and the guide-side projections 22z located closer to the other side D3b are inclined to the lateral non-matching portion 210y at a higher degree toward the rear edge 210b, that is, spacing between the guide distal ends 222 of the adjacent guide-side projections 22z is made larger than spacing between the guide proximal ends 221. However, the angle of the each of the guide-side projections 22z is not particularly limited, and all the guide-side projections 22z may be placed with the same angle of inclination.

Note that even if the guide portion 210 does not include the lateral non-matching portion 210y protruding from the receiving portion main body 200, and the guide portion 210 and the receiving portion main body 200 are equal in dimension in the width direction D3, it is possible to bring the condensate water W into contact in a wide area with the condenser 4 in such a manner as to spread the condensate water W toward both sides D3a and D3b in the width direction D3 on the guide portion 210 by making the spacing between the guide distal ends 222 larger than the spacing between the guide proximal ends 221.

Moreover, the embodiment is not limited to the case where the guide-side projections 22z are provided only to the lateral matching portion 210x of which the position in the width direction D3 matches the receiving portion main body 200 on the guide portion 210. For example, the number of the guide-side projections 22z provided to the lateral matching portion 210x may be greater than the number of the guide-side projections 22z provided to the lateral non-matching portion 210y. Specifically, as illustrated in FIG. 12, the guide-side projection 22z located farthest on the other side D3b in the width direction D3 is inclined in the width direction D3, so that a part of the guide-side projection 22z is placed in the lateral non-matching portion 210y. However, in this case, only one guide-side projection 22z is provided to the lateral non-matching portion 210y, and on the other hand, a plurality of the guide-side projections 22z is provided to the lateral matching portion 210x.

Moreover, both of the main body-side projections 22x and the guide-side projections 22z are not necessarily required.

### INDUSTRIAL APPLICABILITY

According to an air-conditioning apparatus of the present invention, it is possible to guide condensate water from an evaporator to a condenser regardless of the installation position and to improve operation efficiency.

### LIST OF REFERENCE SIGNS

1 Housing
2 Compressor
3 Evaporator
4 Condenser
7 Decompression device
8 Control device
9 Refrigerant pipe
9a First pipe
9b Second pipe
9b Second pipe
9c Third pipe
9d Fourth pipe
20 Condensate water receiving portion
21 Receiving surface
21x Front receiving surface
21y Rear receiving surface
21z Guide-side receiving surface
22 Guide projection
22x Main body-side projection
22z Guide-side projection
23 Lateral protruding portion
23a First protruding portion
23b Second protruding portion
100 Air-conditioning apparatus
200 Receiving portion main body
210 Guide portion
210a Front edge
210b Rear edge
210x Lateral matching portion
210y Lateral non-matching portion
221 Guide proximal end
222 Guide distal end
D1 Front-rear direction
D2 Up-down direction
D3 Width direction
FC1 Main body-side channel
FC2 Guide-side channel
S Non-overlapping space
SS Gap
W Condensate water

1. An air-conditioning apparatus comprising:
a refrigerant circuit including a compressor, a condenser, a decompression device, an evaporator, and a refrigerant channel that connects the compressor, the condenser, the decompression device, and the evaporator, in which a refrigerant circulates; and
a condensate water receiving portion placed between the evaporator and the condenser below the evaporator, the condensate water receiving portion being configured to guide condensate water produced in the evaporator toward a surface of the condenser in a front-rear direction intersecting a width direction of the evaporator, wherein
the condensate water receiving portion includes:
a receiving surface that receives the condensate water, and
a plurality of guide projections spaced apart from one another in the width direction, each of the guide projections protruding upward from the receiving surface and extending in the front-rear direction.

2. The air-conditioning apparatus according to claim 1, wherein
the condensate water receiving portion includes:
a receiving portion main body that includes a part of the receiving surface as a main body-side receiving surface and collects the condensate water; and
a guide portion that includes a part of the receiving surface as a guide-side receiving surface, has one edge connected to the receiving portion main body, has the other edge close to or in contact with the surface of the condenser, and has the guide-side receiving surface below the main body-side receiving surface, and
the plurality of guide projections includes a plurality of main body-side projections provided on the main body-side receiving surface of the receiving portion main body and/or a plurality of guide-side projections provided on the guide-side receiving surface of the guide portion.

3. The air-conditioning apparatus according to claim 2, wherein
the guide portion is larger in dimension in the width direction than the receiving portion main body,
the plurality of guide projections includes the plurality of guide-side projections, and
the number of the guide-side projections provided to a portion of the guide portion in the width direction, the position of the portion in the width direction matching the receiving portion main body (hereinafter, a lateral matching portion), is greater than the number of the guide-side projections provided to a portion of the guide portion in the width direction, the position of the portion in the width direction being different from the receiving portion main body (hereinafter, a lateral non-matching portion).

4. The air-conditioning apparatus according to claim 3, wherein the plurality of guide-side projections is provided only to the lateral matching portion of the guide portion.

5. The air-conditioning apparatus according to claim 3, wherein
the guide portion is provided in such a manner as to protrude from the receiving portion main body toward one side in the width direction, and
each of the plurality of guide-side projections is inclined to the one side in the width direction, from the one edge side toward the other edge side of the guide portion.

6. The air-conditioning apparatus according to claim 2, wherein
the plurality of guide projections includes the plurality of guide-side projections, and
in terms of each of the plurality of guide-side projections, assuming that an end on the one edge side of the guide portion is defined as a guide proximal end and an end on the other edge side is defined as a guide distal end, spacing between the guide distal ends of the plurality of guide-side projections is larger than spacing between the guide proximal ends.

7. The air-conditioning apparatus according to claim 2, wherein
the evaporator and the condenser are placed in such a manner as to exchange heat with air flowing in the front-rear direction,
the plurality of guide projections includes the plurality of main body-side projections, and
a channel for the condensate water formed by the main body-side projections adjacent to each other in the width direction and the receiving surface is provided with a lateral protruding portion protruding upward from the receiving surface in a part of the channel in the width direction.

8. The air-conditioning apparatus according to claim 7, wherein
a plurality of the lateral protruding portions is provided to one channel, spaced apart in the front-rear direction, and
the plurality of the lateral protruding portions that is provided in the one channel and is adjacent to each other in the front-rear direction is placed at positions displaced in the width direction.

9. The air-conditioning apparatus according to claim 8, wherein
assuming that the plurality of the lateral protruding portions that is provided in the one channel and is adjacent to each other in the front-rear direction is defined as a first protruding portion and a second protruding portion, the first protruding portion is connected to one of the main body-side projections adjacent to each other in the width direction, and the second protruding portion is connected to the other of the main body-side projections adjacent to each other in the width direction and overlaps the first protruding portion as viewed in the front-rear direction.

10. The air-conditioning apparatus according to claim 1 to mounted on a vehicle.

11. The air-conditioning apparatus according to claim 2 mounted on a vehicle.

12. The air-conditioning apparatus according to claim 3 mounted on a vehicle.

13. The air-conditioning apparatus according to claim 4 mounted on a vehicle.

14. The air-conditioning apparatus according to claim 5 mounted on a vehicle.

15. The air-conditioning apparatus according to claim 6 mounted on a vehicle.

16. The air-conditioning apparatus according to claim 7 mounted on a vehicle.

17. The air-conditioning apparatus according to claim 8 mounted on a vehicle.

18. The air-conditioning apparatus according to claim 9 mounted on a vehicle.
